(19) United States
(12) Patent Application Publication
(10) Pub. No.: US 2019/0019446 A1
(43) Pub. Date: Jan. 17, 2019

(54) TRIGGER CIRCUIT OF DISCHARGE SIGNALS, AND DISPLAY DEVICE

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Xianming ZHANG, Shenzhen, Guangdong (CN)

(21) Appl. No.: 15/576,806

(22) PCT Filed: Sep. 11, 2017
(86) PCT No.: PCT/CN2017/101178

§ 371 Date: Nov. 25, 2017

(30) Foreign Application Priority Data
Jul. 17, 2017 (CN) 201710582604.5

(51) Int. Cl. G09G 3/32

(52) U.S. Cl. CPC G09G 3/32; G09G 2330/027; G09G 2310/061; G09G 2310/0251

(57) ABSTRACT

In a trigger circuit of discharge signals of the present disclosure, the trigger circuit includes a driving voltage source, a first division voltage unit, a trigger terminal of discharge signals, and a second division voltage unit. A resistance of the first division voltage unit is adjusted by an off signal of a backlight or an off signal of a display device, such that the trigger terminal is configured for outputting the discharge signal. The present disclosure also discloses a display device.

### BACKGROUND

### Field

The present disclosure relates to a technical field of display devices, and more particularly to a trigger circuit of discharge signals, and a display device.

### Background

With development of display technology, requirements for better performance of display devices are increasing. In the display devices, discharge functions are needed to pull potential of a plurality of scan signals to a preset level, such as a lower level or high level.

In related art, discharging is triggered by detecting an off state of a driving voltage VCC of a display device. However, when the display device stops working, a voltage of the driving voltage VCC quickly drops. The discharging is insufficient to pull the potential of the scan signals to the preset level, such as a high level. Thus, since the potential of the scan signals cannot be effectively fell, the discharging of the display device is downgraded, thereby causing errors when the display device is started.

Therefore, there is a need to provide a trigger circuit of discharge signals, and a display device, so as to solve the problems in the related art.

### SUMMARY OF THE DISCLOSURE

Embodiments of the present disclosure provide a trigger circuit of discharge signals and a display device, such that the stability of a discharge reset operation of scan signals in pixel units of the display device is improved. The present disclosure improves a discharge effect of discharge functions in the display device, such that malfunction of the display device can be solved, when the display device is started.

An embodiment of the present disclosure provides a trigger circuit of discharge signals. The trigger circuit includes a driving voltage source, a first division voltage unit, a trigger terminal of discharge signals, and a second division voltage unit.

A first terminal of the first division voltage unit is coupled to the driving voltage source, and a second terminal of the first division voltage unit is coupled to a trigger terminal of discharge signals and the second division voltage unit.

The trigger terminal is configured to output a discharge signal.

A first terminal of the second division voltage unit is coupled to the trigger terminal, and a second terminal of the second division voltage unit is grounded.

A resistance of the first division voltage unit is adjusted by an off signal of a backlight or an off signal of a display device, such that the trigger terminal is configured for outputting the discharge signal.

The second division voltage unit is a fixed resistor.

When the resistance of the first division voltage unit is greater than a preset value, the trigger terminal is configured to output the discharge signal.

In the trigger circuit in the present disclosure, when the resistance of the first division voltage unit is adjusted by the off signal of the backlight, the first division voltage unit includes a first resistor and a first switch transistor.

A terminal of the first resistor is coupled to a driving voltage source, and the other terminal of the first resistor is coupled to an input terminal of the first switch transistor. An output terminal of the first switch transistor is coupled to a trigger terminal of the discharge signals. The off signal of the backlight is input to a control terminal of the first switch transistor.

In the trigger circuit in the present disclosure, when the resistance of the first division voltage unit is adjusted by the off signal of the display device, the first division voltage unit includes a photo-resistor for receiving the off signal of the display device.

A terminal of the photo-resistor is coupled to the driving voltage source, and the other terminal of the photo-resistor is coupled to the trigger terminal.

In the trigger circuit of the present disclosure, the driving circuit in the display device corresponding to the trigger circuit includes a rectification unit. The rectification unit includes a rectification bridge, a light emitting diode, an isolation diode, and a storage capacitor.

An alternating current voltage is input to an input terminal of the rectification bridge. A first output terminal and a second output terminal of the rectification bridge are configured to output a direct current voltage.

The light emitting diode is configured to generate an off signal of the display device, wherein a positive electrode of the light emitting diode is coupled to the first output terminal of the rectification bridge, a negative electrode of the light emitting diode is grounded.

A positive electrode of the isolation diode is coupled to the first output terminal of the rectification bridge, and a negative electrode of the isolation diode is coupled to one terminal of the storage capacitor.

The other terminal of the storage capacitor is coupled to the second output terminal of the rectification bridge.

In one embodiment of the present disclosure, a trigger circuit includes a driving voltage source, a first division voltage unit, a trigger terminal of discharge signals, and a second division voltage unit.

A first terminal of the first division voltage unit is coupled to the driving voltage source, and a second terminal of the first division voltage unit is coupled to a trigger terminal of discharge signals and the second division voltage unit.

The trigger terminal is configured to output a discharge signal.

A first terminal of the second division voltage unit is coupled to the trigger terminal, and a second terminal of the second division voltage unit is grounded.

A resistance of the first division voltage unit is adjusted by an off signal of a backlight or an off signal of a display device, such that the trigger terminal is configured for outputting the discharge signal.

In the trigger circuit of the present disclosure, when the resistance of the first division voltage unit is adjusted by the off signal of the backlight, the first division voltage unit includes a first resistor and a first switch transistor.

A terminal of the first resistor is coupled to a driving voltage source, the other terminal of the first resistor is coupled to an input terminal of the first switch transistor. An output terminal of the first switch transistor is coupled to a trigger terminal of the discharge signals. The off signal of the backlight is input to a control terminal of the first switch transistor.

In the trigger circuit of the present disclosure, when the resistance of the first division voltage unit is adjusted by the off signal of the display device, the first division voltage unit includes a photo-resistor for receiving the off signal of the display device.

A terminal of the photo-resistor is coupled to the driving voltage source, and the other terminal of the photo-resistor is coupled to the trigger terminal.

In the trigger circuit of the present disclosure, the driving circuit in the display device corresponding to the trigger circuit includes a rectification unit. The rectification unit includes a rectification bridge, a light emitting diode, an isolation diode, and a storage capacitor.

An alternating current voltage is input to an input terminal of the rectification bridge. A first output terminal and a second output terminal of the rectification bridge are configured to output a direct current voltage.

The light emitting diode is configured to generate an off signal of the display device, wherein a positive electrode of the light emitting diode is coupled to the first output terminal of the rectification bridge, a negative electrode of the light emitting diode is grounded.

A positive electrode of the isolation diode is coupled to the first output terminal of the rectification bridge, and a negative electrode of the isolation diode is coupled to one terminal of the storage capacitor.

The other terminal of the storage capacitor is coupled to the second output terminal of the rectification bridge.

In one embodiment, the second division voltage unit is a fixed resistor.

In one embodiment, when the resistance of the first division voltage unit is greater than a preset value, the trigger terminal is configured to output the discharge signal.

In one embodiment of the present disclosure, a display device includes a trigger circuit of discharge signals wherein the trigger circuit performs a discharge reset operation for the scan signals, and the scan signals correspond to pixel units of the display device. The trigger circuit includes a driving voltage source, a first division voltage unit, a trigger terminal of discharge signals, and a second division voltage unit.

A first terminal of the first division voltage unit is coupled to the driving voltage source, and a second terminal of the first division voltage unit is coupled to a trigger terminal of discharge signals and the second division voltage unit.

The trigger terminal is configured to output a discharge signal.

A first terminal of the second division voltage unit is coupled to the trigger terminal, and a second terminal of the second division voltage unit is grounded.

A resistance of the first division voltage unit is adjusted by an off signal of a backlight or an off signal of a display device, such that the trigger terminal is configured for outputting the discharge signal.

In the trigger circuit in the present disclosure, when the resistance of the first division voltage unit is adjusted by the off signal of the backlight, the first division voltage unit includes a first resistor and a first switch transistor.

A terminal of the first resistor is coupled to a driving voltage source, the other terminal of the first resistor is coupled to an input terminal of the first switch transistor. An output terminal of the first switch transistor is coupled to a trigger terminal of the discharge signals. The off signal of the backlight is input to a control terminal of the first switch transistor.

In the trigger circuit in the present disclosure, when the resistance of the first division voltage unit is adjusted by the off signal of the display device, the first division voltage unit includes a photo-resistor for receiving the off signal of the display device.

A terminal of the photo-resistor is coupled to the driving voltage source, and the other terminal of the photo-resistor is coupled to the trigger terminal.

In the trigger circuit in the present disclosure, the driving circuit in the display device corresponding to the trigger circuit includes a rectification unit. The rectification unit includes a rectification bridge, a light emitting diode, an isolation diode, and a storage capacitor.

An alternating current voltage is input to an input terminal of the rectification bridge. A first output terminal and a second output terminal of the rectification bridge are configured to output a direct current voltage.

The light emitting diode is configured to generate an off signal of the display device, wherein a positive electrode of the light emitting diode is coupled to the first output terminal of the rectification bridge, a negative electrode of the light emitting diode is grounded.

A positive electrode of the isolation diode is coupled to the first output terminal of the rectification bridge, and a negative electrode of the isolation diode is coupled to one terminal of the storage capacitor.

The other terminal of the storage capacitor is coupled to the second output terminal of the rectification bridge.

In one embodiment, the second division voltage unit is a fixed resistor.

In one embodiment, when the resistance of the first division voltage unit is greater than a preset value, the trigger terminal is configured to output the discharge signal.

The trigger circuit and display device in the present disclosure are configured for adjusting the resistance of the first division voltage unit using the off signal of the display device and the off signal of the display device, such that stability of a discharge reset operation of the scan signals in pixel units is improved. The present disclosure improves a discharge effect of discharge function in the display device, such that malfunction of the display device can be solved, when the display device is started.

### BRIEF DESCRIPTION OF THE DRAWINGS

The following embodiments refer to the accompanying drawings for exemplifying specific implementable embodiments of the present disclosure in a suitable computing environment. It should be noted that the exemplary described embodiments are configured to describe and understand the present disclosure, but the present disclosure is not limited thereto.

FIG. 1 is an illustrative structural diagram of a trigger circuit of discharge signals according to one embodiment of the present disclosure.

FIG. 2a is an illustrative structural diagram of a trigger circuit of discharge signals according to a first preferred embodiment of the present disclosure.

FIG. 2b is an illustrative structural diagram of a rectification unit of a driving circuit in a display device corresponding to the trigger circuit according to the first preferred embodiment of the present disclosure.

FIG. 3 is an illustrative structural diagram of a trigger circuit of discharge signals according to a second preferred embodiment of the present disclosure.

### DETAILED DESCRIPTION OF THE PREFERRED EMBODIMENTS

The following embodiments refer to the accompanying drawings for exemplifying specific implementable embodiments of the present disclosure in a suitable computing environment. It should be noted that the exemplary described embodiments are configured to describe and understand the present disclosure, but the present disclosure is not limited thereto.

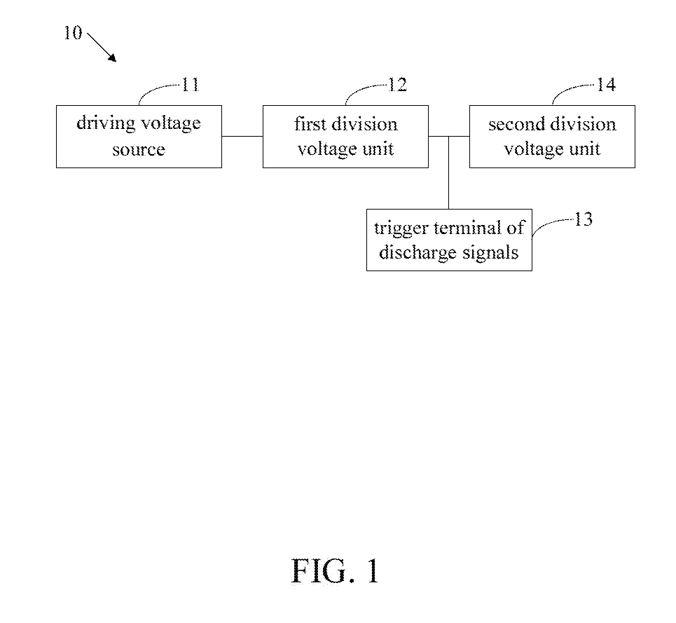

FIG. 1 is an illustrative structural diagram of a trigger circuit according to one embodiment of the present disclosure. The trigger circuit 10 includes a driving voltage source 11, a first division voltage unit (e.g. a division voltage circuit) 12, a trigger terminal 13 of discharge signals, and a second division voltage unit (e.g. a division voltage circuit) 14.

The driving voltage source 11 is configured to generate a driving voltage of a display device. A first terminal of the first division voltage unit 12 is coupled to the driving voltage source 11, and a second terminal of the first division voltage unit 12 is coupled to the trigger terminal 13 and the second division voltage unit 14. The trigger terminal 13 is configured to output the discharge signals. A first terminal of the second division voltage unit 14 is coupled to the trigger terminal 13, and a second terminal of the second division voltage unit 14 is grounded. A resistance of the first division voltage unit 12 can be adjusted by an off signal of a backlight or an off signal of the display device, such that the trigger terminal 13 is configured for outputting the discharge signals. For example, the second division voltage unit 14 is a fixed resistor 141.

The off signal of the backlight is an electric signal for turning off the backlight, where a trigger timing of the off signal of the backlight is slightly earlier than a trigger timing of an off signal of the driving signal. Thus, when the off signal of the backlight is configured to trigger the discharge signal, a driving circuit of the display device has sufficient time to perform a discharge reset operation for the scan signals, thereby improving stability of the discharge reset operation of the scan signals.

The off signal of the display device is an electric signal triggered by a physical switch of the display device, where a trigger timing of the off signal of the display device is slightly earlier than a trigger timing of the off signal of the driving signal. Thus, when the off signal of the display device is configured to trigger the discharge signal, a driving circuit of the display device has sufficient time to perform a discharge reset operation for the scan signals, thereby improving stability of the discharge reset operation of the scan signals.

An operation principle of the trigger circuit in the present disclosure is described by the following two embodiments.

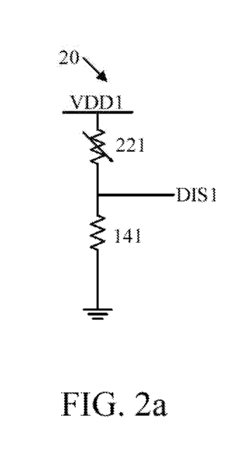

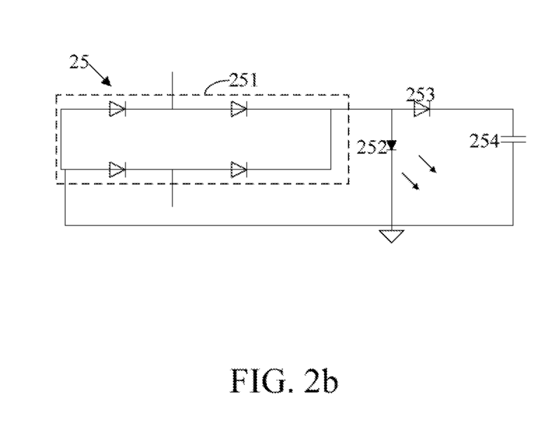

FIG. 2a is an illustrative structural diagram of a trigger circuit of discharge signals according to a first preferred embodiment of the present disclosure. FIG. 2b is an illustrative structural diagram of a rectification unit of a driving circuit in a display device corresponding to the trigger circuit according to the first preferred embodiment of the present disclosure.

When the resistance of the first division voltage unit 12 is adjusted by the off signal of the display device, the first division voltage unit 12 includes a photo-resistor 221 for receiving the off signal of the display device. One terminal of the photo-resistor 221 is coupled to the driving voltage source VDD1, and the other terminal of the photo-resistor 221 is coupled to the trigger terminal DIS1.

The driving circuit in the display device corresponding to the trigger circuit 20 includes a rectification unit 25. The rectification unit 25 includes a rectification bridge 251, a light emitting diode 252, an isolation diode 253, and a storage capacitor 254.

An alternating current voltage is input to an input terminal of the rectification bridge 251. A first output terminal and a second output terminal of the rectification bridge 251 are configured to output a direct current voltage. A positive electrode of the light emitting diode 252 is coupled to the first output terminal of the rectification bridge 251. A negative electrode of the light emitting diode 252 is grounded. The light emitting diode 252 is configured to generate an off signal of the display device. A positive electrode of the isolation diode 253 is coupled to the first output terminal of the rectification bridge 251. A negative electrode of the isolation diode 253 is coupled to one terminal of the storage capacitor 254. The other terminal of the storage capacitor 254 is coupled to the second output terminal of the rectification bridge 251.

In the trigger circuit 20 of the present disclosure, when the driving circuit in the display device works normally, the light emitting diode 252 emits light, such that the photo-resistor 221 of the first division voltage unit 12 in the trigger circuit 20 is irradiated by the light, and the resistance of the photo-resistor 221 is smaller or approaches zero. Since the resistance of the first division voltage unit 12 is less than or equal to a preset value, the trigger terminal DIS1 outputs a higher voltage and the discharge signal is not triggered.

When the trigger circuit 20 is in an off state, the alternating current voltage is not input to the input terminal of the rectification bridge 251. The first output terminal and the second output terminal of the rectification bridge 251 stop outputting the direct current voltage. Meanwhile, the light emitting diode 252 stops emitting the light immediately. Charges in the storage capacitor 254 are configured to keep the driving voltage VCC in an on state. Meanwhile, since the photo-resistor 221 of the first division voltage unit 12 is not irradiated by the light, and the resistance of the photo-resistor 221 is increased, such that the resistance of the first division voltage unit 12 is greater than the preset value. Thus, the trigger terminal DIS1 outputs a smaller voltage and the discharge signal is triggered. When the discharge signal is triggered, the driving voltage VCC is not decreased, thereby improving stability of the discharge reset operation of the scan signals in pixel units.

Therefore, a trigger process of discharge signals of the trigger circuit 20 in the present disclosure is completed.

The trigger circuit 20 of the present disclosure is configured for adjusting the resistance of the first division voltage unit 12 using the off signal of the display device, such that stability of the discharge reset operation of the scan signals in pixel units is improved.

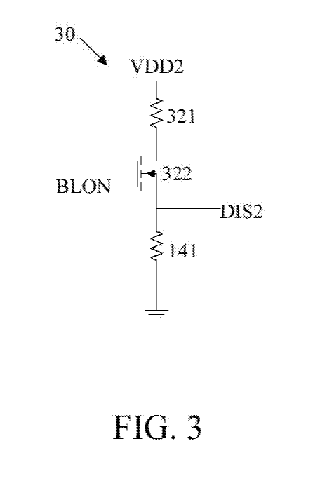

FIG. 3 is an illustrative structural diagram of a trigger circuit 30 of discharge signals according to a second preferred embodiment of the present disclosure.

When the resistance of the first division voltage unit 12 is adjusted by the off signal of the backlight, the first division voltage unit 12 includes a first resistor 321 and a first switch transistor 322. One terminal of the first resistor 321 is coupled to a driving voltage source VDD2, and the other terminal of the first resistor 321 is coupled to an input terminal of the first switch transistor 322. An output terminal of the first switch transistor 322 is coupled to a trigger terminal DIS2 of the discharge signals, and the off signal BLON of the backlight is input to a control terminal of the first switch transistor 322.

In the trigger circuit 30 of the present disclosure, when a backlight unit in the display device works normally, the off signal BLON of the backlight is configured as a high level signal to be input to the control terminal of the first switch transistor 322, such that the first switch transistor 322 turns on, and a resistance of the first division voltage unit 12 in the trigger circuit 30 is smaller. Since the resistance of the first division voltage unit 12 is less than or equal to a preset value, the trigger terminal DIS2 outputs a higher voltage and the discharge signal is not triggered.

When the backlight unit of the display device is in an off state, the off signal BLON of the backlight is configured as a low level signal to be input to the control terminal of the first switch transistor 322, such that the first switch transistor 322 turns off, and a resistance of the first division voltage unit 12 in the trigger circuit 30 is greater. The resistance of the first division voltage unit 12 is greater than the preset value. Thus, the trigger terminal DIS2 outputs a smaller voltage and the discharge signal is triggered. When the discharge signal is triggered, the driving voltage VCC is not decreased, thereby improving stability of the discharge reset operation of the scan signals in pixel units.

Therefore, a trigger process of discharge signals of the trigger circuit 30 in the present disclosure is completed.

The trigger circuit 30 of the present disclosure is configured for adjusting the resistance of the first division voltage unit 12 using the off signal of the display device, such that stability of the discharge reset operation of the scan signals in pixel units is improved.

The present disclosure further discloses a display device having a trigger circuit of discharge signals. The trigger circuit performs a discharge reset operation for the scan signals, where the scan signals correspond to pixel units of the display device.

The trigger circuit includes a driving voltage source, a first division voltage unit, a trigger terminal of discharge signals, and a second division voltage unit.

The driving voltage source is configured to generate a driving voltage of a display device. A first terminal of the first division voltage unit is coupled to the driving voltage source, and a second terminal of the first division voltage unit is coupled to the trigger terminal and the second division voltage unit. The trigger terminal is configured to output the discharge signals. A first terminal of the second division voltage unit is coupled to the trigger terminal, and a second terminal of the second division voltage unit is grounded. A resistance of the first division voltage unit can be adjusted by an off signal of a backlight or an off signal of the display device, such that the trigger terminal is configured for outputting the discharge signals.

In one embodiment, when the resistance of the first division voltage unit is adjusted by the off signal of the backlight, the first division voltage unit includes a first resistor and a first switch transistor. One terminal of the first resistor is coupled to a driving voltage source, and the other terminal of the first resistor is coupled to an input terminal of the first switch transistor. An output terminal of the first switch transistor is coupled to a trigger terminal of the discharge signals, and the off signal of the backlight is input to a control terminal of the first switch transistor.

In one embodiment, when the resistance of the first division voltage unit is adjusted by the off signal of the display device, the first division voltage unit includes a photo-resistor for receiving the off signal of the display device. One terminal of the photo-resistor is coupled to the driving voltage source, and the other terminal of the photo-resistor is coupled to the trigger terminal.

The driving circuit in the display device corresponding to the trigger circuit includes a rectification unit. The rectification unit includes a rectification bridge, a light emitting diode, an isolation diode, and a storage capacitor. An alternating current voltage is input to an input terminal of the rectification bridge. A first output terminal and a second output terminal of the rectification bridge are configured to output a direct current voltage. A positive electrode of the light emitting diode is coupled to the first output terminal of the rectification bridge. A negative electrode of the light emitting diode is grounded. The light emitting diode is configured to generate an off signal of the display device. A positive electrode of the isolation diode is coupled to the first output terminal of the rectification bridge. A negative electrode of the isolation diode is coupled to one terminal of the storage capacitor. The other terminal of the storage capacitor is coupled to the second output terminal of the rectification bridge.

The trigger circuit and a display device in the present disclosure are configured for adjusting the resistance of the first division voltage unit using the off signal of the display device and the off signal of the display device, such that stability of a discharge reset operation of the scan signals in pixel units is improved. The present disclosure improves a discharge effect of discharge function in the display device, such that malfunction of the display device can be solved, when the display device is started.

As is understood by a person skilled in the art, the foregoing preferred embodiments of the present disclosure are illustrative rather than limiting of the present disclosure. It is intended that they cover various modifications and similar arrangements be included within the spirit and scope of the present disclosure, the scope of which should be accorded the broadest interpretation so as to encompass all such modifications and similar structures.

1. A trigger circuit of discharge signals, comprising:
a driving voltage source;
a first terminal of a first division voltage circuit coupled to the driving voltage source;
a trigger terminal configured to output a discharge signal; and
a second division voltage circuit having a first terminal coupled to the trigger terminal, and a second terminal grounded wherein a second terminal of the first division voltage circuit is coupled to the trigger terminal and the second division voltage circuit;
wherein a resistance of the first division voltage circuit is adjusted by an off signal of a backlight or an off signal of a display device, such that the trigger terminal is configured for outputting the discharge signal;
wherein the second division voltage circuit is a fixed resistor;
wherein when the resistance of the first division voltage circuit is greater than a preset value, the trigger terminal is configured to output the discharge signal.

2. The trigger circuit according to claim 1, wherein when the resistance of the first division voltage circuit is adjusted by the off signal of the backlight, the first division voltage circuit comprises a first resistor and a first switch transistor;
wherein a terminal of the first resistor is coupled to a driving voltage source, the other terminal of the first resistor is coupled to an input terminal of the first switch transistor, an output terminal of the first switch transistor is coupled to the trigger terminal, and the off signal of the backlight is input to a control terminal of the first switch transistor.

3. The trigger circuit according to claim 1, wherein when the resistance of the first division voltage circuit is adjusted by the off signal of the display device, the first division voltage circuit comprises a photo-resistor for receiving the off signal of the display device;
wherein a terminal of the photo-resistor is coupled to the driving voltage source, and the other terminal of the photo-resistor is coupled to the trigger terminal.

4. The trigger circuit according to claim 3, wherein the driving circuit in the display device corresponding to the trigger circuit comprises a rectification unit, the rectification unit comprising:
an alternating current voltage input to an input terminal of a rectification bridge, and a first output terminal and a second output terminal of the rectification bridge configured to output a direct current voltage;
a light emitting diode configured to generate an off signal of the display device, wherein a positive electrode of the light emitting diode is coupled to the first output terminal of the rectification bridge, a negative electrode of the light emitting diode is grounded;
a positive electrode of an isolation diode coupled to the first output terminal of the rectification bridge, a negative electrode of the isolation diode coupled to one terminal of a storage capacitor; and
the other terminal of the storage capacitor coupled to the second output terminal of the rectification bridge.

5. A trigger circuit of discharge signals, comprising:
a driving voltage source;
a first terminal of a first division voltage circuit coupled to the driving voltage source;
a trigger terminal configured to output a discharge signal; and
a second division voltage circuit having a first terminal coupled to the trigger terminal, and a second terminal grounded, wherein a second terminal of the first division voltage circuit is coupled to the trigger terminal and the second division voltage circuit;
wherein a resistance of the first division voltage circuit is adjusted by an off signal of a backlight or an off signal of a display device, such that the trigger terminal is configured for outputting the discharge signal.

6. The trigger circuit according to claim 5, wherein when the resistance of the first division voltage circuit is adjusted by the off signal of the backlight, the first division voltage circuit comprises a first resistor and a first switch transistor;
wherein a terminal of the first resistor is coupled to a driving voltage source, the other terminal of the first resistor is coupled to an input terminal of the first switch transistor, an output terminal of the first switch transistor is coupled to the trigger terminal, and the off signal of the backlight is input to a control terminal of the first switch transistor.

7. The trigger circuit according to claim 5, wherein when the resistance of the first division voltage circuit is adjusted by the off signal of the display device, the first division voltage circuit comprises a photo-resistor for receiving the off signal of the display device;
wherein a terminal of the photo-resistor is coupled to the driving voltage source, and the other terminal of the photo-resistor is coupled to the trigger terminal.

8. The trigger circuit according to claim 7, wherein the driving circuit in the display device corresponding to the trigger circuit comprises a rectification unit, the rectification unit comprising:
an alternating current voltage input to an input terminal of a rectification bridge, and a first output terminal and a second output terminal of the rectification bridge configured to output a direct current voltage;
a light emitting diode configured to generate an off signal of the display device, wherein a positive electrode of the light emitting diode is coupled to the first output terminal of the rectification bridge, a negative electrode of the light emitting diode is grounded;
a positive electrode of an isolation diode coupled to the first output terminal of the rectification bridge, a negative electrode of the isolation diode coupled to one terminal of a storage capacitor; and
the other terminal of the storage capacitor coupled to the second output terminal of the rectification bridge.

9. The trigger circuit according to claim 5, wherein the second division voltage circuit is a fixed resistor.

10. The trigger circuit according to claim 5, wherein when the resistance of the first division voltage circuit is greater than a preset value, the trigger terminal is configured to output the discharge signal.

11. A display device having a trigger circuit of discharge signals, wherein the trigger circuit performs a discharge reset operation for scan signals, and the scan signals correspond to pixel units of the display device, the trigger circuit comprising:
a driving voltage source;
a first terminal of a first division voltage circuit coupled to the driving voltage source;
a trigger terminal configured to output a discharge signal; and
a second division voltage circuit having a first terminal coupled to the trigger terminal, and a second terminal grounded, wherein a second terminal of the first division voltage circuit is coupled to the trigger terminal and the second division voltage circuit;
wherein a resistance of the first division voltage circuit is adjusted by an off signal of a backlight or an off signal of a display device, such that the trigger terminal is configured for outputting the discharge signal.

12. The display device according to claim 11, wherein when the resistance of the first division voltage circuit is adjusted by the off signal of the backlight, the first division voltage circuit comprises a first resistor and a first switch transistor;
wherein a terminal of the first resistor is coupled to a driving voltage source, the other terminal of the first resistor is coupled to an input terminal of the first switch transistor, an output terminal of the first switch transistor is coupled to the trigger terminal, and the off signal of the backlight is input to a control terminal of the first switch transistor.

13. The display device according to claim 11, wherein when the resistance of the first division voltage circuit is adjusted by the off signal of the display device, the first division voltage circuit comprises a photo-resistor for receiving the off signal of the display device:
wherein a terminal of the photo-resistor is coupled to the driving voltage source, and the other terminal of the photo-resistor is coupled to the trigger terminal.

14. The display device according to claim 13, wherein the driving circuit in the display device corresponding to the trigger circuit comprises a rectification unit, the rectification unit comprising:
an alternating current voltage input to an input terminal of a rectification bridge, and a first output terminal and a second output terminal of the rectification bridge configured to output a direct current voltage;
a light emitting diode configured to generate an off signal of the display device, wherein a positive electrode of the light emitting diode is coupled to the first output terminal of the rectification bridge, a negative electrode of the fight emitting diode is grounded;
a positive electrode of an isolation diode coupled to the first output terminal of the rectification bridge, a negative electrode of the isolation diode coupled to one terminal of a storage capacitor; and
the other terminal of the storage capacitor coupled to the second output terminal of the rectification bridge.

15. The display device according to claim 11, wherein the second division voltage circuit is a fixed resistor.

16. The display device according to claim 11, wherein when the resistance of the first division voltage circuit is greater than a preset value, the trigger terminal is configured to output the discharge signal.

17. The trigger circuit of discharge signals according to claim 1, wherein the off signal of the backlight is an electric signal for turning off the backlight, and the off signal of the display device is an electric signal triggered by a physical switch of the display device.

18. The trigger circuit of discharge signals according to claim 5, wherein the off signal of the backlight is an electric signal for turning off the backlight, and the off signal of the display device is an electric signal triggered by a physical switch of the display device.

19. The trigger circuit of discharge signals according to claim 11, wherein the off signal of the backlight is an electric signal for turning off the backlight, and the off signal of the display device is an electric signal triggered by a physical switch of the display device.
